(19) United States
(12) Patent Application Publication
(10) Pub. No.: US 2016/0369818 A1
(43) Pub. Date: Dec. 22, 2016

(54) FUEL PUMP

(71) Applicant: DENSO CORPORATION, Kariya-city (JP)

(72) Inventors: Hiromi SAKAI, Kariya-city (JP); Yuuji HIDAKA, Kariya-city (JP); Masaya OOTAKE, Kariya-city (JP)

(21) Appl. No.: 15/185,142

(22) Filed: Jun. 17, 2016

(30) Foreign Application Priority Data
Jun. 17, 2015 (JP) 2015-121750

(51) Int. Cl. F04D 29/66; F04D 29/02; F04D 29/40; F04D 29/24; F02M 37/08; F04D 13/06

(52) U.S. Cl. CPC F04D 29/669; F02M 37/08; F04D 13/0693; F04D 29/406; F04D 29/24; F04D 29/026; F05D 2240/20; F05D 2260/94

(57) ABSTRACT

A fuel pump includes a cylindrical stator having a plurality of windings, a rotor rotatably disposed radially inward of the stator, a shaft integrally rotatable with the rotor, an impeller including a fitting hole to which an end portion of the shaft is fitted, and a balance weight disposed in the impeller. The balance weight is formed so as to be symmetrical about a point of symmetry lying on an axial center of the impeller.

### CROSS REFERENCE TO RELATED APPLICATION

The present application is based on Japanese Patent Application No. 2015-121750 filed on Jun. 17, 2015, disclosure of which is incorporated herein by reference.

### TECHNICAL FIELD

The present disclosure relates to a fuel pump.

### BACKGROUND

It is known that a type of fuel pump includes a pump unit and a motor unit. The pump unit includes a pump chamber that rotatably houses an impeller. The motor unit includes a shaft coupled to the impeller, and generates a driving force able to rotate the impeller. As the impeller rotates, the fuel pump pumps fuel from a fuel tank to an internal combustion engine. For example, JP H11-82208 A describes a fuel pump that includes a shaft having an end portion formed with a substantially D-shaped cross section and an impeller having a fitting hole that fits with the end portion of the shaft, wherein a hole is formed to adjust a weight balance in a perpendicular direction with respect to the center axis of the impeller.

### SUMMARY

The impeller included in the fuel pump pressurizes fuel flowing into the pump chamber from a center axis direction of the impeller, and discharges this pressurized fuel in the center axis direction toward an opposite side from the side of the unpressurized fuel flowing into the pump camber. If the fuel flowing into the pump chamber includes easily vaporized components such as alcohol components, air bubbles may for in the fuel based on the environmental conditions during operation of the fuel pump. In the fuel pump, a clearance is formed between the impeller and the inner wall of the pump chamber such that the impeller is able to rotate. Accordingly, depending on the amount and the position of the air bubbles, the impeller may repeatedly oscillate in the center axis direction of the impeller. In this case, since friction is repeatedly generated between the impeller and the shaft fitted to the fitting hole, there is a concern that the impeller may be damaged.

It is an object of the present disclosure to provide a fuel pump that prevents an impeller from damage.

According to the present disclosure, a fuel pump includes a pump case including an inlet port and a discharge port, a stator, a rotor rotatably disposed radially inward of the stator, a shaft disposed coaxially with the rotor, the shaft being integrally rotatable with the rotor, an impeller including a fitting hole in which an end portion of the shaft is fitted, the impeller being configured to pressurize the fuel sucked in from the inlet port and discharge the fuel from the discharge port when the shaft rotates, and a balance weight disposed in the impeller, the balance weight being formed so as to be symmetrical about a point of symmetry lying on a center axis of the impeller.

According to the fuel pump of the present disclosure, the weight of the components which vibrate in the center axis direction of the impeller due to movement of air bubbles in the fuel, i.e., the combination of the impeller than the balance weight, is set to a weight such that vibrations are reduced. Therefore, the number of times that the shaft and the impeller slide against each other may be reduced, and the impeller may be protected from damage caused by friction.

### BRIEF DESCRIPTION OF THE DRAWINGS

The disclosure, together with additional objectives, features and advantages thereof, will be best understood from the following description, the appended claims and the accompanying drawings, in which:

FIG. 1 is a cross section view of a fuel pump according to a first embodiment;

FIG. 2 is a schematic view of an impeller included in the fuel pump of the first embodiment;

FIG. 3 is a schematic view explaining the operation of the fuel pump of the first embodiment;

FIG. 4 is a schematic view of an impeller included in a fuel pump of a second embodiment;

FIG. 5 is a schematic view of an impeller included in a fuel pump of a third embodiment; and

FIG. 6 is a cross section view of a fuel pump of a fourth embodiment;

### DETAILED DESCRIPTION

A plurality of embodiments of the present disclosure will be explained with reference to the figures.

### First Embodiment

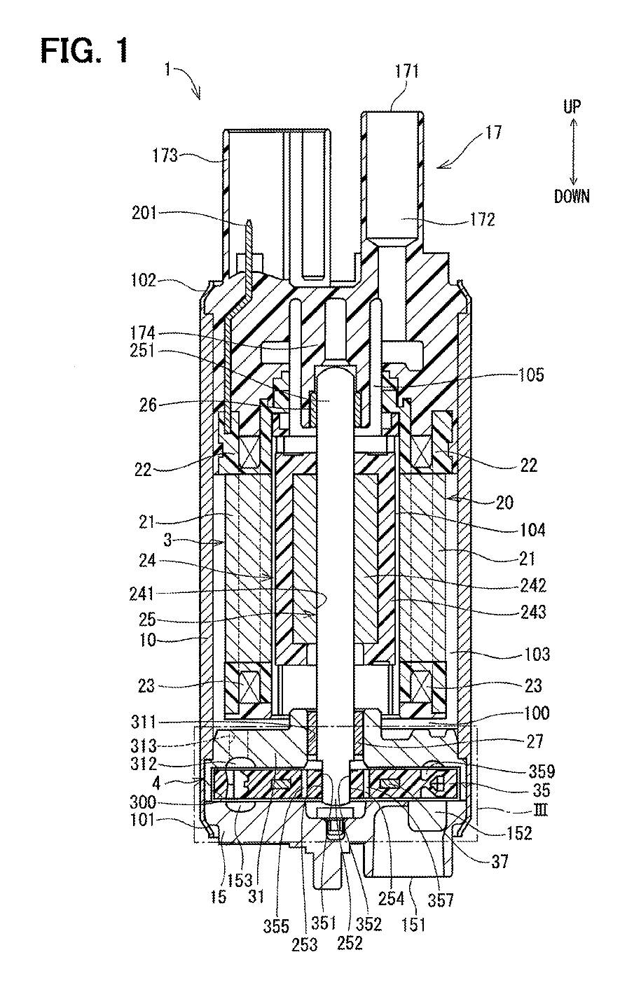

A fuel pump according to a first embodiment of the present disclosure will be explained with reference to FIGS. 1 to 3.

A fuel pump 1 includes a housing 10, a motor unit 3, a pump unit 4, a pump cover 15, and a cover end 17. In the fuel pump 1, the motor unit 3 and the pump unit 4 are housed within a space defined by the housing 10, the pump cover 15, and the cover end 17. The fuel pump 1 takes in fuel from a fuel tank (not illustrated) through an intake port 151, and discharges this fuel through a discharge port 171 to an internal combustion engine. In addition, in FIG. 1, the upward direction is referred to as “up” or “top”, while the downward direction is referred to as “down” or “bottom”. The housing 10, the pump cover 15, and the cover end 17 correspond to a “pump case”.

The housing 10 is formed in a cylindrical shape from a metal such as iron. The pump cover 15 and the cover end 17 are disposed at a bottom end portion 101 and a top end portion 102 of the housing 10, respectively.

The pump cover 15 is disposed so as to cover the bottom end portion 101 of the housing 10. The edge of the bottom end portion 101 is crimped inward to fix the pump cover 15 to the inner side of the housing 10. The pump cover 15 includes the intake port 151 which opens toward the bottom side. The intake port 151 is in communication with an intake passage 152 which penetrates up and down through the pump cover 15. In addition, a groove 153, which is in communication with the intake passage 152, is formed on the top side of the pump cover 15.

The cover end 17 is formed of resin, and is disposed so as to cover the top end portion 102 of the housing 10. The edge of the top end portion 102 is crimped to fix the cover end 17 to the inner side of the housing 10. The cover end 17 includes the discharge port 171 which opens upward. The discharge port 171 is in communication with a discharge passage 172 that penetrates up and down through the cover end 17. In addition, an electrical connector portion 173 is disposed in a different part of the cover end 17 than the part forming the discharge port 171. The electrical connector portion 173 houses a connection terminal 201 which receives electric power from an external source. A substantially cylindrical bearing housing portion 174 is disposed on the bottom side of the cover end 17. A bearing 26 is inserted into the bearing housing portion 174. The bearing 26 rotatably supports an upper end portion 251 of a shaft 25.

When electric power is supplied to the motor unit 3, a magnetic field is generated. The motor unit 3 uses this magnetic field to generate a rotation torque. The motor unit 3 includes a stator 20, a rotor 24, and the shaft 25. In addition, the motor unit 3 of the fuel pump 1 according to the first embodiment is a brushless motor that is able to detect the position of the rotor 24 with respect to the stator 20 due to the rotation of the shaft 25.

The stator 20 is cylindrical shaped, and is housed within the housing 10. The stator 20 includes six cores 21, six bobbins 22, six windings 23, and three connection terminals 201. The stator 20 is formed by integrally molding these components with resin.

The core 21 is formed by stacking a plurality of magnetic members, each of which may be, for example, an iron sheet. The core 21 is arranged in the circumferential direction and positioned to face a magnet 243 of the rotor 24.

The bobbins 22 are formed of a resin material, and the core 21 is inserted during molding. Accordingly, the bobbins 22 are integrally provided with the core 21.

The windings 23 may be, for example, copper wiring coated with an insulating film. One of the windings 23 forms a coil by winding around one of the bobbins 22 with the core 21 inserted. The windings 23 are electrically connected to the connection terminal 201 housed in the electrical connector portion 173.

The connection terminal 201 penetrates through the cover end 17 and is fixed to the top of the bobbins 22. According to the fuel pump 1 of the first embodiment, three connection terminals 201 are provided, and receive three-phase electric power from a power source device (not illustrated).

The rotor 24 is rotatably disposed inside of the stator 20. The rotor 24 includes a magnet 243 disposed around an iron core 242. The magnet 243 is arranged with alternating N poles and S poles.

The shaft 25 is formed with a substantially circular cross section perpendicular to the center axis, except for a lower end portion 252 which corresponds to “an end portion”. The shaft 25 is fixedly press fit into a shaft hole 241 formed in the center axis of the rotor 24. Accordingly, the shaft 25 and the rotor 24 integrally rotate.

The lower end portion 252 of the shaft 25 is formed with a substantially rectangular cross section perpendicular to the center axis. The lower end portion 252 is connected to the pump unit 4. The lower end portion 252 includes shaft contact surfaces 253, 254 which are formed as flat surfaces extending toward the top.

The pump unit 4 uses the rotation torque generated by the motor unit 3 to pressurize fuel sucked in from the intake port 151, and discharges this fuel into the housing 10. The pump unit 4 includes a pump casing 31, an impeller 35, and a balance weight 37.

The pump casing is substantially discoid shaped, and is disposed between the pump cover 15 and the stator 20. A throughhole 311 is formed in the center portion of the pump casing 31 and penetrates through the pump casing 31 in the thickness direction. A bearing 27 is fitted inside the throughhole 311. The bearing 27 rotatably supports the lower end portion 252 of the shaft 25. Accordingly, the rotor 24 and the shaft 25 are rotatable with respect to the cover end 17 and the pump casing 31.

In addition, a groove 312 is formed on the bottom side of the pump casing 31, and is positioned to face the groove 153 of the pump cover 15. The groove 312 is in communication with a fuel passage 313 which penetrates up and down through the pump casing 31.

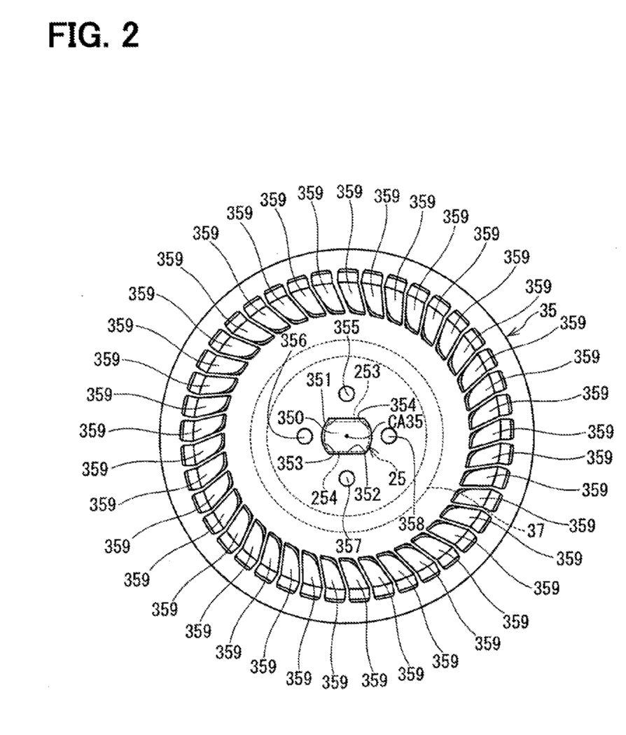

The impeller 35 is substantially discoid shaped, and is formed by, for example, PPS resin. The impeller 35 is housed within a pump chamber 300 defined between the pump cover 15 and the pump casing 31. A fitting hole 350 is formed in substantially the center of the impeller 35 (see FIG. 2), and the lower end portion 252 of the shaft 25 is fitted into the fitting hole 350. The fitting hole 350 is formed by two flat surfaces 351, 352 and two curve surfaces 353, 354. The two curved surfaces 353, 354 are connected to either end of the two flat surfaces 351, 352. In addition, the two fiat surfaces 351, 352 are abuttable with the shaft contact surfaces 253, 254.

Holes 355, 356, 357, 358 are formed in the impeller 35 around the fitting hole 350, and penetrate up and down through the impeller 35. The holes 355, 356, 357, 358 connect the top and bottom sides of the impeller 35 in the pump chamber 300, and allow fuel to flow such that the fuel pressure in the pump chamber 300 is not biased.

The impeller 35 includes a plurality of vane grooves 359 located radially outward of the fitting hole 350. The vane grooves 359 are disposed at locations corresponding to the groove 153 and the groove 312. The vane grooves 359 are, as shown in FIG. 2, disposed at the radially outward edge portion of the impeller 35 with equal spacing in the circumferential direction.

The balance weight 37 is disposed inside the impeller 35. The balance weight 37 may be, for example, formed as an insert and disposed inside the impeller 35 so as to be integral with the impeller 35. As shown in FIG. 2, the balance weight 37 is disposed radially outward of the holes 355, 355, 357, 358. The balance weight has a greater specific gravity than the resin forming the impeller 35, and may be formed of metal for example. The balance weight 37 has an annular shape so as to be symmetrical with the point of symmetry lying on the center axis CA35 of the impeller 35.

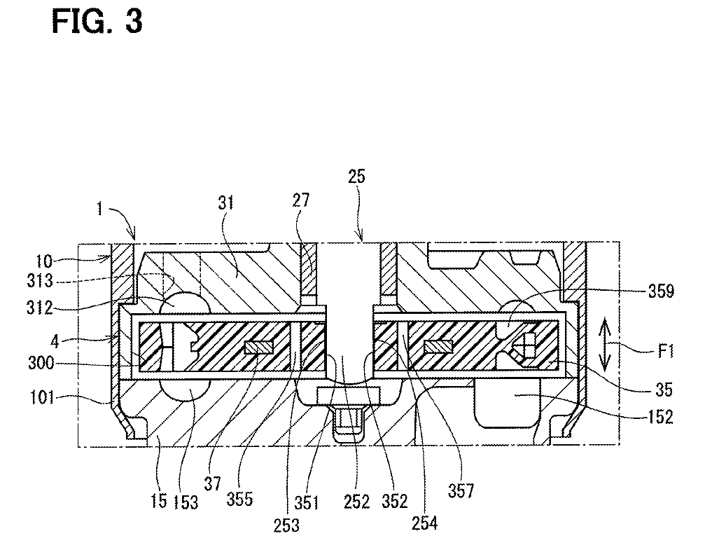

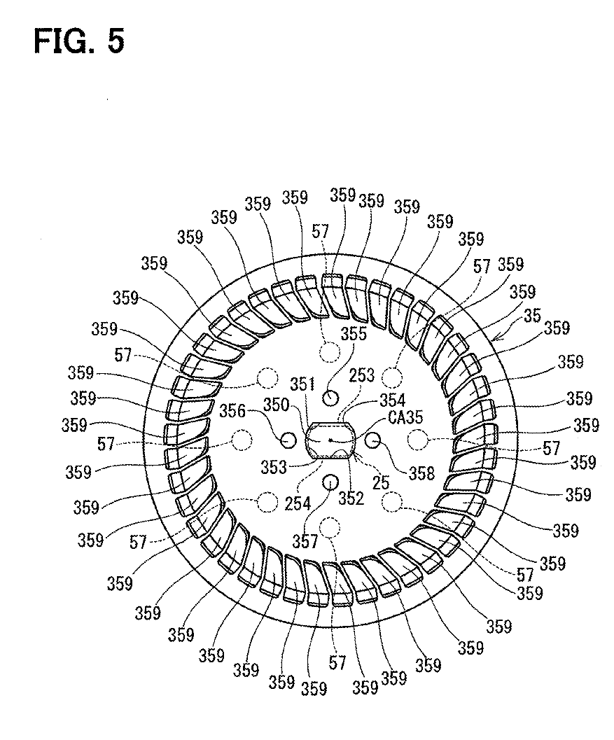

Next, the operation of the fuel pump 1 will be explained with reference to FIGS. 1 and 3. In addition, for easy of understanding, the clearance between the impeller 35 and the wall surfaces of the pump cover 15 and the pump casing 31 which form the pump chamber 300 is illustrated as bigger than normal in FIG. 5.

According to the fuel pump 1, when the windings of the motor unit 3 are supplied with electric power through the connection terminal 201, the rotor 24 and the shaft 25, along with the impeller 35, rotate. When the impeller 35 rotates, the fuel pump 1 sucks in fuel from a fuel tank through the intake port 151 into the grooves 153, 312 of the pump chamber 300. Due to the rotation of the impeller 35, the sucked in fuel flows in a spiral swirl flow between the vane grooves 359 and the grooves 153, 312, and is pressurized. The pressurized fuel is guided through the fuel passage 313 and into an intermediate chamber 100 formed between the pump casing 31 and the motor unit 3.

The fuel guided into the intermediate chamber 100 is guided through a fuel passage 103 and a fuel passage 104 into a fuel passage 105. The fuel passage 103 is formed between the inner wall of the housing 10 and the outer wall of the stator 20. The fuel passage 104 is formed between the rotor 24 and the stator 20. The fuel passage 105 is formed radially outward of the bearing housing portion 174. The fuel guided into the fuel passage 105 is discharged through the discharge passage 172 and the discharge port 171.

In the fuel pump 1, when alcohol components are included in the fuel sucked in from the intake port 151 into the pump chamber 300, air bubbles may be generated in the sucked in fuel according to the operating environmental conditions of the fuel pump 1. As shown in FIG. 5, according to the fuel pump 1, a fixed amount of clearance is disposed between the impeller 35 and the inner walls of the pump chamber 300. For this reason, when fuel including air bubbles is sucked into the pump chamber 300, the impeller 35 vibrates up and down as shown by the double ended arrow F1 in FIG. 3 according to the amount of air bubbles and the positions of the air bubbles with respect to the impeller 35. As the impeller 35 vibrates up and down, the shaft contact surfaces 253, 254 of the shaft 25 repeatedly slide against the flat surfaces 351, 352 which form the fitting hole 350.

(a) According to the fuel pump 1, the balance weight 37, which is formed of a metal having a greater specific gravity than the resin forming the impeller 35, is disposed in the impeller 35. Accordingly, the weight of the components vibrating in the pump chamber 300 is greater as compared to if the components are formed of only resin. As a result, the frequency of the impeller 35 with respect to the shaft may be comparatively reduced. Therefore, the number of times that the shaft 25 and the impeller 35 slide against each other may be reduced, and the impeller 35 may be protected from damage caused by friction.

(b) In addition, the balance weight 37 is formed as a single annular member. Accordingly, production costs associated with inserting the balance weight into the impeller 35 may be reduced. As a result, the overall production costs of the fuel pump 1 may be reduced.

### Second Embodiment

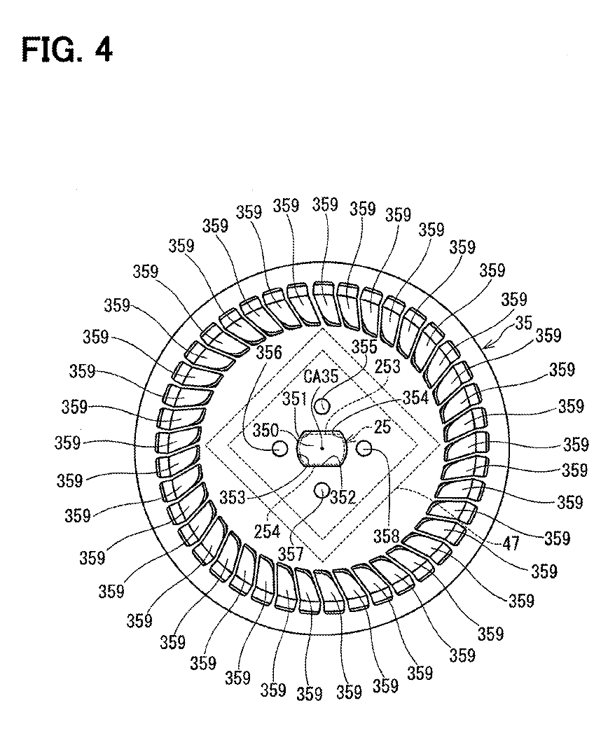

Next, a fuel pump of a second embodiment of the present disclosure will be explained with reference to FIG. 4. In the second embodiment, the shape of the a balance weight is different from the first embodiment. In addition, portions which are substantially the same as those of the first embodiment are denoted with the same reference numeral, and explanations thereof are omitted for brevity.

FIG. 4 is a schematic view of an impeller 35 included in a fuel pump according to the second embodiment. A balance weight 47 is disposed in the impeller 35.

The balance weight 47 may be, for example, formed as an insert and disposed inside the impeller 35 so as to be integral with the impeller 35. The balance weight 47 is formed of metal, and has an annular square shape so as to be symmetrical about a point of symmetry lying on the center axis CA35 of the impeller 35.

According to the fuel pump of the second embodiment, the balance weight 47, which is formed of a metal having a greater specific gravity than the resin forming the impeller 35, is disposed in the impeller 35. Accordingly, the weight of the components vibrating in the pump chamber 300 is increased, and so the number of times that the shaft 25 and the impeller 35 slide against each other due to air bubbles being generated in the fuel may be reduced. Accordingly, at least the same effects (a) and (b) of the first embodiment may be exhibited in the second embodiment.

### Third Embodiment

Next, a fuel pump of a third embodiment of the present disclosure will be explained with reference to FIG. 5. In the third embodiment, the shape of the a balance weight is different from the first embodiment. In addition, portions which are substantially the same as those of the first embodiment are denoted with the same reference numeral, and explanations thereof are omitted for brevity.

FIG. 5 is a schematic view of an impeller 35 included in a fuel pump according to the third embodiment. A balance weight 57 is disposed in the impeller 35.

The balance weight 57 may be, for example, formed as inserts and disposed inside the impeller 35 so as to be integral with the impeller 35. The balance weight 57 is plurally disposed as substantially column shaped members formed of metal. According to the third embodiment, 8 balance weights 57 are disposed. The 8 balance weights 57 are positioned symmetrically about a point of symmetry lying on the center axis CA35 of the impeller 35.

According to the fuel pump of the third embodiment, the 8 balance weights 57, which are formed of a metal having a greater specific gravity than the resin forming the impeller 35, is disposed in the impeller 35. Accordingly, the weight of the components vibrating in the pump chamber 300 is increased, and so the number of times that the shaft 25 and the impeller 35 slide against each other due to air bubbles being generated in the fuel may be reduced. Accordingly, at least the same effect (a) of the first embodiment may be exhibited in the third embodiment.

### Fourth Embodiment

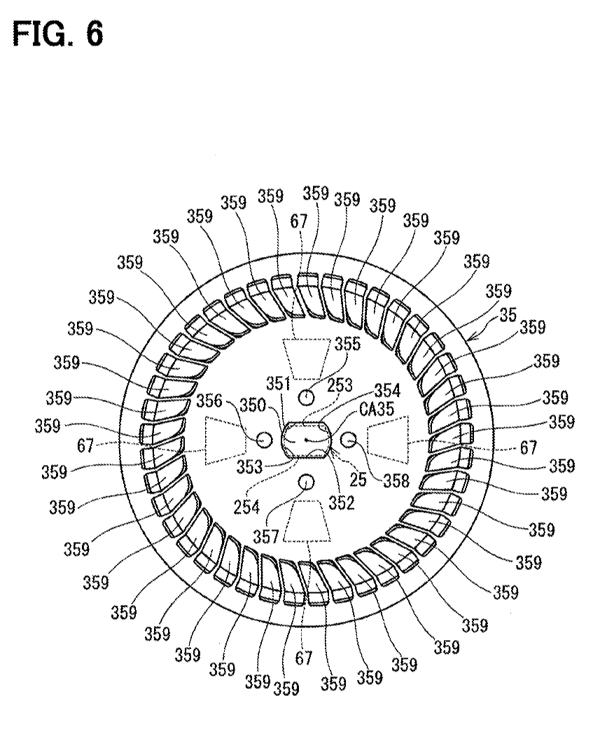

Next, a fuel pump of a fourth embodiment of the present disclosure will be explained with reference to FIG. 6. In the fourth embodiment, the shape of the a balance weight is different from the first embodiment. In addition, portions which are substantially the same as those of the first embodiment are denoted with the same reference numeral, and explanations thereof are omitted for brevity.

FIG. 6 is a schematic view of an impeller 35 included in a fuel pump according to the fourth embodiment. A balance weight 67 is disposed in the impeller 35.

The balance weight 67 may be, for example, formed as inserts and disposed inside the impeller 35 so as to be integral with the impeller 35. The balance weight 67 is plurally disposed as substantially trapezoidal members formed of metal. According to the fourth embodiment, 4 balance weights 67 are disposed. The 4 balance weights 67 are positioned symmetrically about a point of symmetry lying on the center axis CA35 of the impeller 35.

According to the fuel pump of the fourth embodiment, the 4 balance weights 67, which are formed of a metal having a greater specific gravity than the resin forming the impeller 35, is disposed in the impeller 35. Accordingly, the weight of the components vibrating in the pump chamber 300 is increased, and so the number of times that the shaft 25 and the impeller 35 slide against each other due to air bubbles being generated in the fuel may be reduced. Accordingly, at least the same effect (a) of the first embodiment may be exhibited in the fourth embodiment.

### Other Embodiments

In the above described embodiments, the lower end portion of the shaft fitted in the fitting hole of the impeller includes two shaft contact surfaces. However, there may be only one shaft contact surface instead.

In the above described embodiments, the balance weight is formed of metal. However, the balance is weight is limited to being formed of such a material. if the balance weight is disposed outside of the impeller, then the balance weight may be formed of a material having the same specific gravity as the material forming the impeller. However, if the balance weight is inserted into the impeller as in the above embodiments, it is preferably that the balance weight is formed of a material having a different specific gravity than the material forming the impeller.

In the first and second embodiments, the balance weight is formed in an annular shape. In the third embodiment, the balance weight is configured as multiple substantially column shaped members. In the fourth embodiment, the balance weight is configured as multiple substantially trapezoidal members. However, the shape and number of the balance weight is not limited to these examples, as long as the balance weight is symmetrical about a point of symmetry on the center axis of the impeller.

In the above described embodiments, the balance weight is disposed radially outward of the holes, but may be disposed radially inward of the holes instead.

In the above described embodiments, the balance weight is disposed inside the impeller, but may be disposed on the outer wall of the impeller instead.

The present disclosure is not limited to these embodiments, and variety of modifications which do not depart from the gist of the present disclosure are contemplated.

1. A fuel pump, comprising:
a pump case including an inlet port that sucks in fuel and a discharge port that discharges the fuel;
a cylindrical stator including a plurality of windings, the stator being fixed inside the pump case;
a rotor rotatably disposed radially inward of the stator;
a shaft disposed coaxially with the rotor, the shaft integrally rotating with the rotor;
an impeller including a fitting hole in which an end portion of the shaft is fitted, the impeller being configured to pressurize the fuel sucked in from the inlet port and discharge the fuel from the discharge port when the shaft rotates; and
a balance weight disposed in the impeller, the balance weight being formed so as to be symmetrical about a point of symmetry lying on a center axis of the impeller

2. The fuel pump of claim 1, wherein
the balance weight is formed as an annular integral member.

3. The fuel pump of claim 1, wherein
the balance weight is plurally disposed.

4. The fuel pump of claim 3, wherein
the plurality of balance weights are disposed along a circumferential direction of the impeller.

5. The fuel pump of claim 1, wherein
the balance weight is formed of a material having a different specific gravity than a material forming the impeller.

6. The fuel pump of claim 5, wherein
the balance weight is formed of a material having a greater specific gravity than the material forming the impeller.
